(19) United States
(12) Patent Application Publication
(10) Pub. No.: US 2024/0283522 A1
(43) Pub. Date: Aug. 22, 2024

(54) USER EQUIPMENT-ASSISTED PHASE RECOVERY FOR COHERENT JOINT TRANSMISSION

(71) Applicant: QUALCOMM Incorporated, San Diego, CA (US)

(72) Inventors: Kiran Venugopal, Green Brook, NJ (US); Wooseok Nam, San Diego, CA (US); Tao Luo, San Diego, CA (US)

(21) Appl. No.: 18/169,940

(22) Filed: Feb. 16, 2023

(51) Int. Cl. H04B 7/08; H04L 5/00; H04W 72/1268; H04W 76/15

(52) U.S. Cl. CPC H04B 7/0848; H04L 5/0048; H04W 72/1268; H04W 76/15

(57) ABSTRACT

This disclosure provides systems, methods, and devices for wireless communication that support UE-assisted phase recovery for CJT. In a first aspect, a method of wireless communication includes transmitting an indication of a phase alignment associated with a first network node and a second network node at a first user equipment (UE), receiving, from the first network node, a first CJT component after transmitting the indication of the phase alignment, and receiving, from the second network node, a second CJT component after transmitting the indication of the phase alignment, wherein a first phase of the first CJT component is aligned with a second phase of the second CJT component. Other aspects and features are also claimed and described.

### TECHNICAL FIELD

Aspects of the present disclosure relate generally to wireless communication systems, and more particularly, to coherent joint transmission (CJT). Some features may enable and provide improved communications, including user equipment (UE)-assisted phase recovery for CJT.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication performed by a first UE includes transmitting an indication of a phase alignment associated with a first network node and a second network node at the first UE, receiving, from the first network node, a first CJT component after transmitting the indication of the phase alignment, and receiving, from the second network node, a second CJT component after transmitting the indication of the phase alignment, wherein a first phase of the first CJT component is aligned with a second phase of the second CJT component.

In an additional aspect of the disclosure, a first UE includes a memory storing processor-readable code and at least one processor coupled to the memory. The at least one processor is configured to execute the processor-readable code to cause the at least one processor to transmit an indication of a phase alignment associated with a first network node and a second network node, receive, from the first network node, a first coherent joint transmission (CJT) component after transmitting the indication of the phase alignment, and receive, from the second network node, a second CJT component after transmitting the indication of the phase alignment, wherein a first phase of the first CJT component is aligned with a second phase of the second CJT component.

In an additional aspect of the disclosure, a first UE includes means for transmitting an indication of a phase alignment associated with a first network node and a second network node at the first UE, means for receiving, from the first network node, a first CJT component after transmitting the indication of the phase alignment, and means for receiving, from the second network node, a second CJT component after transmitting the indication of the phase alignment, wherein a first phase of the first CJT component is aligned with a second phase of the second CJT component.

In an additional aspect of the disclosure, a non-transitory computer-readable medium stores instructions that, when executed by a processor of a first UE, cause the processor to perform operations. The operations include transmitting an indication of a phase alignment associated with a first network node and a second network node at the first UE, receiving, from the first network node, a first CJT component after transmitting the indication of the phase alignment, and receiving, from the second network node, a second CJT component after transmitting the indication of the phase alignment, wherein a first phase of the first CJT component is aligned with a second phase of the second CJT component.

In an additional aspect of the disclosure, a method for wireless communication performed by a first network node includes receiving, from a first UE, an indication of a phase alignment associated with the first network node and a second network node at the first UE, determining a phase alignment parameter for a first coherent joint transmission (CJT) component by the first network node based on the received indication, and transmitting, to the first UE, the first CJT component in accordance with the determined phase alignment parameter.

In an additional aspect of the disclosure, a first network node includes a memory storing processor-readable code and at least one processor coupled to the memory. The at least one processor is configured to execute the processor-readable code to cause the at least one processor to receive, from a first UE, an indication of a phase alignment associated with the first network node and a second network node at the first UE, determine a phase alignment parameter for a first coherent joint transmission (CJT) component by the first network node based on the received indication, and transmit, to the first UE, the first CJT component in accordance with the determined phase alignment parameter.

In an additional aspect of the disclosure, a first network node includes means for receiving, from a first UE, an indication of a phase alignment associated with the first network node and a second network node at the first UE, means for determining a phase alignment parameter for a first coherent joint transmission (CJT) component by the first network node based on the received indication, and means for transmitting, to the first UE, the first CJT component in accordance with the determined phase alignment parameter.

In an additional aspect of the disclosure, a non-transitory computer-readable medium stores instructions that, when executed by a processor of a first network node, cause the processor to perform operations. The operations include receiving, from a first UE, an indication of a phase alignment associated with the first network node and a second network node at the first UE, determining a phase alignment parameter for a first coherent joint transmission (CJT) transmission by the first network node based on the received indication, and transmitting, to the first UE, the first CJT component in accordance with the determined phase alignment parameter.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3A is a block diagram illustrating a codebook structure mode for CJT according to one or more aspects.

FIG. 3B is a block diagram illustrating a codebook structure mode for CJT according to one or more aspects.

FIG. 4A is a block diagram illustrating an example UE connected to two transmission and reception points (TRPs) according to one or more aspects.

FIG. 4B is a block diagram illustrating an example UE connected to two TRPs according to one or more aspects.

FIG. 5 is a block diagram illustrating an example wireless communication system that supports UE-assisted phase recovery for CJT according to one or more aspects.

FIG. 6 is a flow diagram illustrating an example process that supports UE-assisted phase recovery for CJT according to one or more aspects.

FIG. 7 is a flow diagram illustrating an example process that supports UE-assisted phase recovery for CJT according to one or more aspects.

FIG. 8 is a flow diagram illustrating an example process that supports UE-assisted phase recovery for CJT according to one or more aspects.

FIG. 9 is a flow diagram illustrating an example process that supports UE-assisted phase recovery for CJT according to one or more aspects.

FIG. 10 is a block diagram of an example base station that supports UE-assisted phase recovery for CJT according to one or more aspects.

FIG. 11 is a block diagram of an example UE that supports UE-assisted phase recovery for CJT according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards. A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 millisecond (ms)), and users with wide ranges of mobility or lack thereof; and (3) with enhanced mobile broadband including extreme high capacity (e.g., ˜ 10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

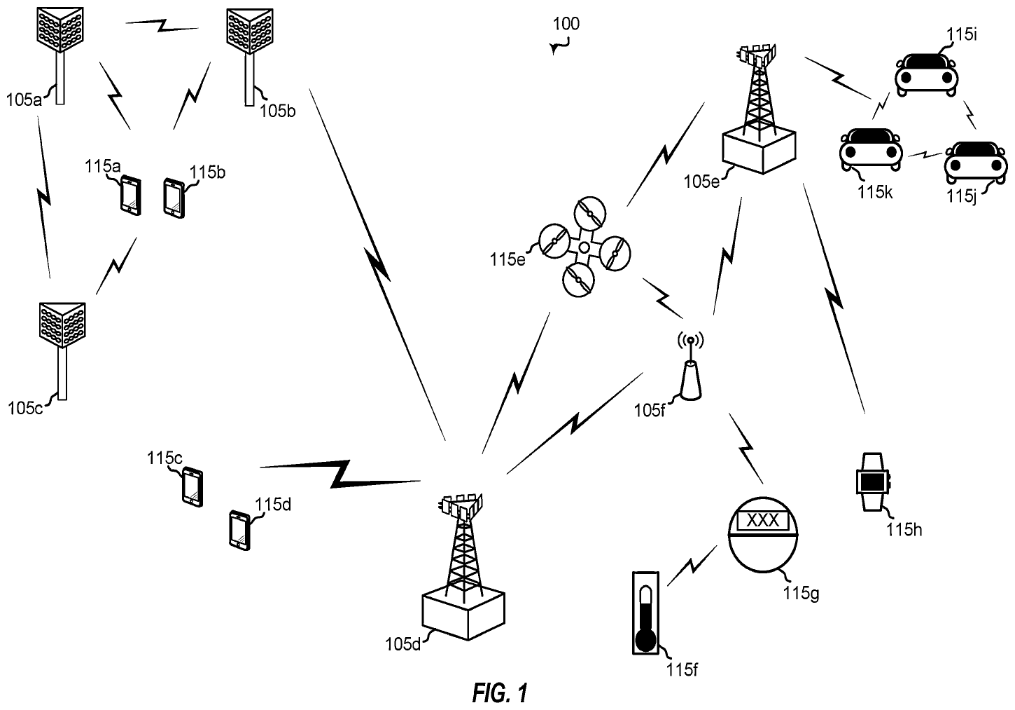

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

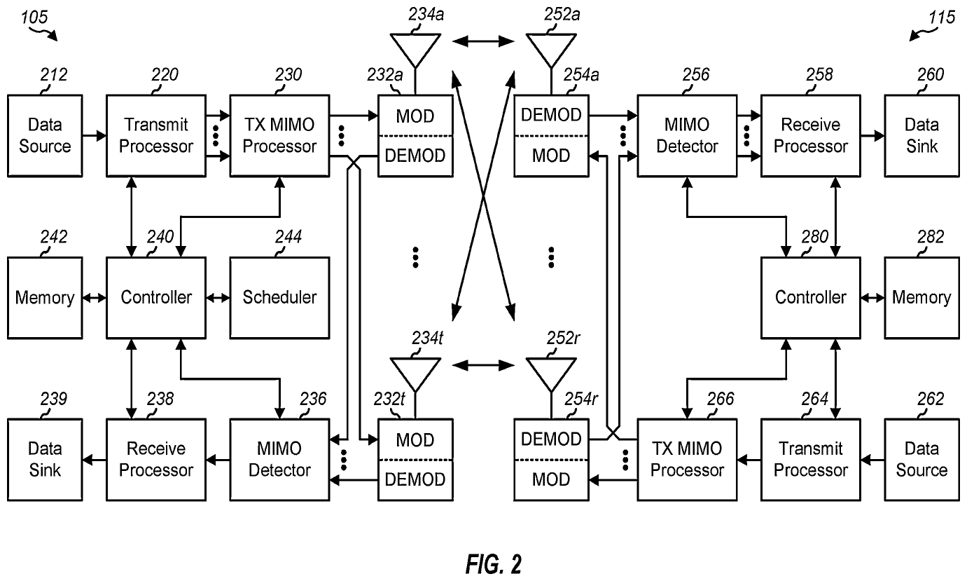

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

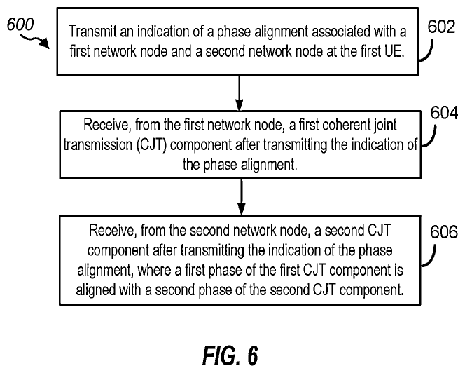

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 6-9, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

The present disclosure provides systems, apparatus, methods, and computer-readable media that support UE-assisted phase recovery for coherent joint transmission. In a CJT configuration, a first UE may communicate with multiple network nodes, such as multiple TRPs, in parallel with a single polarization across communications with the multiple TRPs. For example, a UE may communicate with at least two TRPs in a CJT configuration, with each of the TRPs transmitting phase-aligned components of a CJT transmission for parallel reception at the UE. Communication between the UE and the multiple TRPs is aligned in phase, such as within a threshold phase variance. Small movements of a UE may interfere with maintenance of a coherent phase in CJT communications, leading to inefficiency and reduced reliability. A first UE, configured for CJT communication with first and second network nodes, such as first and second TRPs, may therefore transmit an indication of a phase alignment associated with the first and second network nodes, such as a phase offset, at the first UE. The first and second network nodes may use the indication of the phase alignment to maintain phase coherence in subsequent CJT transmissions from the first and second network nodes to the first UE.

Particular implementations of the subject matter described in this disclosure may be implemented to realize one or more of the following potential advantages or benefits. In some aspects, the present disclosure provides techniques for UE-assisted phase recovery for CJT. Transmission of an indication of a phase alignment to one or more network nodes communicating with a UE in a CJT configuration can allow for maintenance of phase coherence between CJT components transmitted by different network nodes, such as different TRPs, even when a UE is moved from a current location. Such recovery may be particularly useful when CJT components are transmitted at high frequencies, such as 30 GHz or more, where a minimal change in UE position, such as 2.5 mm, may correspond to a substantial change in phase coherence, such as a 180 degree relative phase change. Maintenance of phase coherence can allow for enhanced network efficiency and resilience when operating in a CJT mode, by allowing for phase coherence to be maintained even when conditions, such as a location of a UE, change.

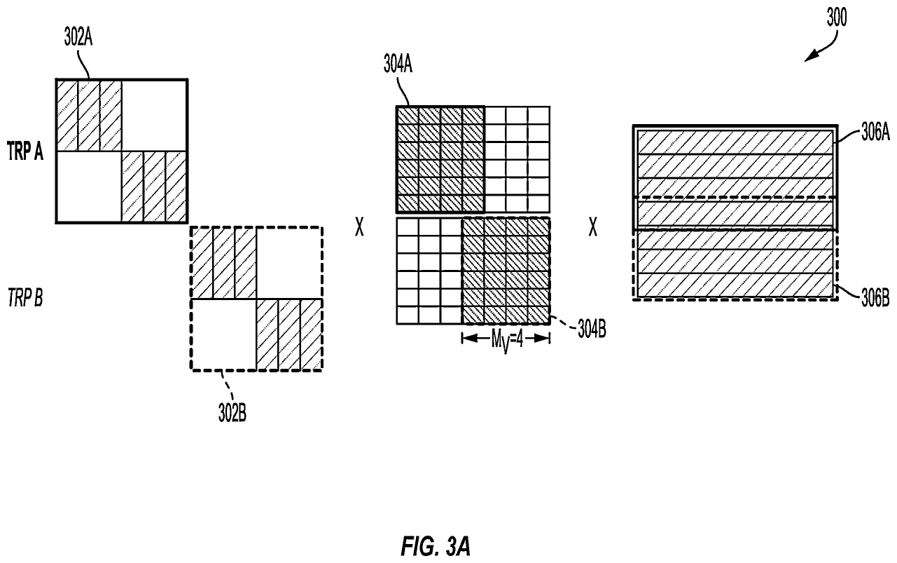

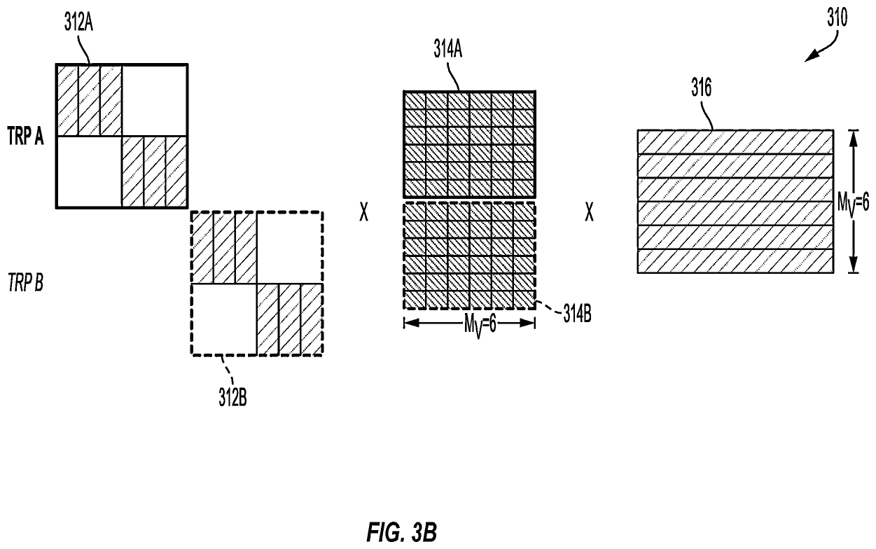

In CJT multiple TRP (mTRP) communication, up to four or more network nodes, such as TRPs, may participate in a CJT session with a UE, transmitting joint phase coherent transmissions to the UE. In some embodiments, a maximum number of TRPs participating in a CJT session may be 4. Multiple different codebook structures may be available for CJT. As one example, a first codebook structure 300, shown in FIG. 3A, may include independent selection of a frequency domain basis, as shown at 306A-B, for each TRP. In particular, a first TRP may be assigned a first spatial domain basis 302A, a first set of W₂ coefficients 304A, and a first set of frequency domain bases 306A. A second TRP may be assigned a second spatial domain basis 302B, a second set of W₂ coefficients 304B, and a second set of frequency domain bases 306B. As another example, a second codebook structure 310, shown in FIG. 3B, may be a joint frequency domain structure, where a frequency domain bases are shared by multiple TRPs, such as through phase alignment in transmissions. A first TRP may be assigned a first spatial domain basis 312A, a first set of W₂ coefficients 314A, and a set of frequency domain bases 316. The second TRP may be assigned a second spatial domain basis 312B, a second set of W₂ coefficients 314B and the set of frequency domain bases 316. Thus, in a joint frequency domain CJT codebook structure 310, multiple TRPs may share the same frequency domain bases.

When using the codebooks structures described herein, network nodes, such as TRPs, transmitting CJT components to a UE may configure such transmissions to be co-phased. That is, CJT components of a CJT transmission transmitted when using the codebooks described herein may be co-phased. One way of adjusting transmission of CJT transmissions to achieve phase coherence is through adjustment of wide-band parameters of the transmissions, such as W₂ coefficients discussed with respect to FIGS. 3A-B. As one example, a UE may be configured to report W₂ entries corresponding to a single phase reporting group, corresponding to a c_{group,phase} parameter equal to one, and two amplitude coefficients, corresponding to a c_{group,amplitude} value equal to 2. Thus, the table of W₂ values may be amplitude enhanced, and for the amplitude group other than a group associated with a strongest coefficient indicator, a reference amplitude may be reported. As another example, a UE may be configured to report W₂ entries corresponding to a single phase reporting group, corresponding to a c_{group,phase} parameter equal to one, and more than two amplitude coefficients, corresponding to a c_{group,amplitude} value equal to 2N. Thus, for each of the 2N−1 amplitude groups, other than the group associated with the strongest coefficient indicator, a reference amplitude may be reported. Based on the W₂ parameter limitations described above, transmissions each CSI-RS resource may be associated with a respective TRP, and co-phasing may be performed across groups with each group consisting of one polarization across all TRPs participating in a CJT communication session. Thus, the co-phasing across groups of TRPs may be implemented, with each group utilizing one polarization across all TRP members of the group. In some embodiments, a channel measurement resource (CMR) may include more than one non-zero power (NZP) CSI-RS resource, with each resource corresponding to one TRP or TRP-group. Each CSI-RS resource may have a same number of CSI-RS ports.

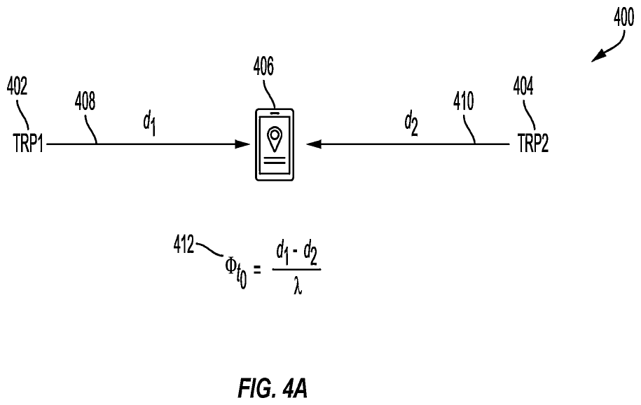

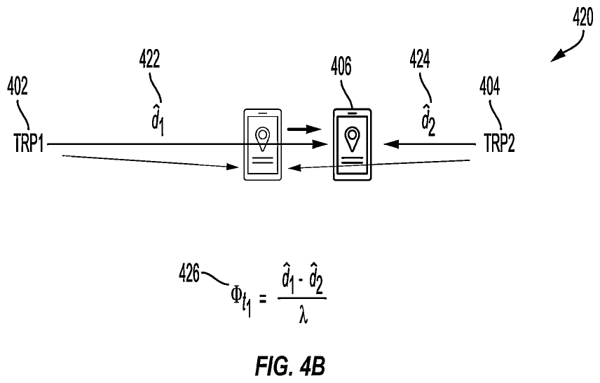

For CJT communication, a network node, such as one or more TRPs included in a base station, may maintain phase coherence during communication windows, even with transitions between transmission and reception. Phase coherence may be disrupted and/or lost when a UE, with which multiple TRPs are communicating in a CJT configuration is moved or a misalignment of a time offset occurs. For example, even a small change in position of the UE may alter effective propagation delays and/or distances from respective TRPs. As another example, phase coherence may be disrupted by use of a time offset between a CSI-RS burst used for CJT channel state information transmissions and a subsequent CJT physical downlink shared channel (PDSCH) transmission that is too great. As one particular example, shown in the network 400 of FIG. 4, a UE 406 may communicate with a first TRP 402 and a second TRP 404 in a CJT configuration. TRPs 402, 404 may be integrated in a same base station or in different base stations. Transmissions from the first TRP 402 and the second TRP 404 to the UE 406 may be transmitted in a phase coherent configuration, such as having a phase alignment with a phase divergence within a predetermined level. That is, transmissions from the first TRP 402 and the second TRP 404 may be transmitted such that the transmissions are aligned in phase when received by the UE 406. A relative phase may, for example, be determined according to the phase equation 412 based on a first distance 408 between the first TRP 402 and the UE 406, a second distance 410 between the second TRP 404 and the UE 406, and a wavelength, λ, of the transmissions. As shown in the network 420 of FIG. 4B, even a small change in position of the UE may result in a relatively large change in relative phase. For example, the UE 406 may be moved such that a distance 422 between the UE 406 and the first TRP 402 increases and the distance 424 between the UE 406 and the second TPR 404 decreases. A new relative phase may be calculated according to the new distances 422, 424. With high carrier frequencies, such as a 30 GHz carrier frequency, a small change in UE position, such as a 2.5 mm change, may correspond to a 180 degree relative phase change. Regular transmissions of an indication of a phase alignment at a UE, from the UE to one or more TRPs, may assist the TRPs in maintaining phase alignment of CJT components.

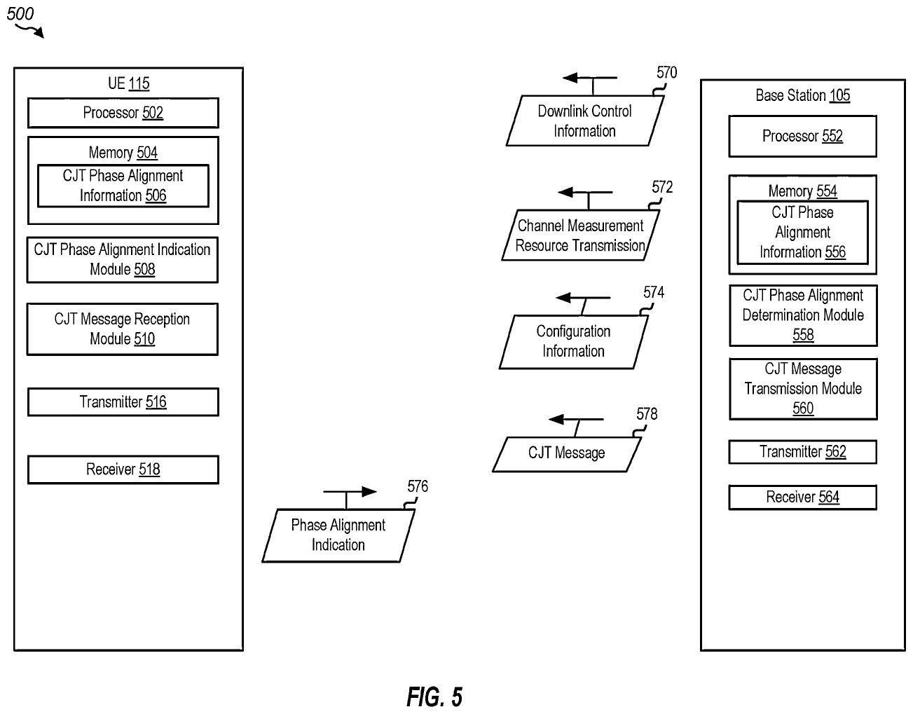

FIG. 5 is a block diagram of an example wireless communications system 500 that supports UE-assisted phase recovery for CJT according to one or more aspects. In some examples, wireless communications system 500 may implement aspects of wireless network 100. Wireless communications system 500 includes UE 115 and base station 105. Although one UE 115 and one base station 105 are illustrated, in some other implementations, wireless communications system 300 may generally include multiple UEs 115, and may include more than one base station 105. In some embodiments, base station 105 may be a gNB including one or more TRPs communicating with the UE 115 in a CJT configuration.

UE 115 may include a variety of components (such as structural, hardware components) used for carrying out one or more functions described herein. For example, these components may include one or more processors 502 (hereinafter referred to collectively as “processor 502”), one or more memory devices 504 (hereinafter referred to collectively as “memory 504”), one or more transmitters 516 (hereinafter referred to collectively as “transmitter 516”), and one or more receivers 518 (hereinafter referred to collectively as “receiver 518”). Processor 502 may be configured to execute instructions stored in memory 504 to perform the operations described herein. In some implementations, processor 502 includes or corresponds to one or more of receive processor 258, transmit processor 264, and controller 280, and memory 304 includes or corresponds to memory 282.

Memory 504 includes or is configured to store CJT phase alignment information 506. CJT phase alignment information 506 may, for example, include information regarding one or more resources on which downlink control information for triggering a transmission of an indication of a phase alignment associated with transmissions of the base station 105 and another base station, or multiple TRPs of the base station 105, at the UE 115. As another example, CJT phase alignment information 506 may include information regarding one or more resources on which one or more CMR transmissions will be transmitted, one or more measurements of one or more CMR transmissions that will be transmitted from the base station 105 and other base stations, and/or one or more phase alignment parameters determined based on measurements of the one or more CMR transmissions. As another example, CJT phase alignment information 506 may include information regarding one or more resources for transmission of one or more reference signal transmissions, such as sounding reference signal (SRS) transmissions, for phase alignment estimation by the base station 105, information regarding one or more offsets between receipt of DCI and transmission of one or more reference signals, information regarding one or more offsets between transmission of one or more reference signals and receipt of one or more CJT components, phase alignment indication information, phase alignment report information, or CJT phase alignment information. For example, CJT phase alignment information 506 may include one or more phase differential values for transmissions from one or more pairs of TRPs, such as TRPs of base station 105 or TRPs of other base stations. Such phase differential values may, for example, be determined by UE 115 based on measurements of one or more signals transmitted by the one or more TRPs, such as one or more CMR transmissions.

Transmitter 516 is configured to transmit reference signals, control information and data to one or more other devices, and receiver 518 is configured to receive references signals, synchronization signals, control information and data from one or more other devices. For example, transmitter 516 may transmit signaling, control information and data to, and receiver 518 may receive signaling, control information and data from, base station 105. In some implementations, transmitter 516 and receiver 518 may be integrated in one or more transceivers. Additionally or alternatively, transmitter 516 or receiver 518 may include or correspond to one or more components of UE 115 described with reference to FIG. 2.

CJT phase alignment indication module 508 may be configured to determine CJT phase alignment information 506, such as one or more indications of phase alignments between two or more TRPs at UE 115 communicating with the UE 115 in a CJT configuration. Such information may, for example, be determined based on measurements of signals transmitted by the base station 105, such as CMR transmissions, based on receipt of DCI triggering reference signal transmissions by the UE to one or more TRPs, or based on other information. In some embodiments, the CJT phase alignment indication module 508 may be configured to cause the transmitter 516 to transmit such an indication to one or more TRPs, such as one or more TRPs of the base station 105 or one or more TRPs of other base stations. CJT message reception module 510 may be configured to receive CJT components from base station 105 and from other base stations. Additionally, CJT message reception module 510 may be configured to receive DCI, CMR transmissions, configuration transmissions, and other transmissions from the base station 105 and other base stations.

Base station 105 may include a variety of components (such as structural, hardware components) used for carrying out one or more functions described herein. For example, these components may include one or more processors 552 (hereinafter referred to collectively as “processor 552”), one or more memory devices 554 (hereinafter referred to collectively as “memory 554”), one or more transmitters 562 (hereinafter referred to collectively as “transmitter 562”), and one or more receivers 564 (hereinafter referred to collectively as “receiver 564”). Processor 552 may be configured to execute instructions stored in memory 554 to perform the operations described herein. In some implementations, processor 552 includes or corresponds to one or more of receive processor 238, transmit processor 220, and controller 240, and memory 354 includes or corresponds to memory 242. In some embodiments, base station 105 may be or include one or more TRPs.

Memory 554 includes or is configured to store CJT phase alignment information 556. CJT phase alignment information may include information for transmission of DCI to UE 115 for triggering a phase alignment indication transmission, information or transmitting one or more CMR transmissions to UE 115 for measuring to determine phase alignment information, configuration information for transmission to configure UE 115 for phase alignment determination for CJT communication, and information for transmitting one or more CJT components in phase alignment with one or more other CJT components. CJT phase alignment information 556 may, for example, include one or more measurements performed by UE 115 on one or more CMR transmissions and transmitted to the base station 105 in a report of a phase alignment indication and/or one or more phase alignment parameters determined by the UE 115 based on measurements of one or more CMR transmissions and transmitted to the base station 105 in a report of a phase alignment indication. Such parameters may, for example, include one or more phase alignment differentials between transmissions received from multiple TRPs. The CJT phase alignment information 556 may include one or more measurements performed by the base station 105 on a phase alignment indication transmitted by the UE 115, such as one or more measurements performed on one or more reference signals transmitted by the UE 115 for determination of a phase alignment by base station 105, and/or one or more phase alignment parameters determined based on measurements performed by the base station 105 on one or more reference signal transmissions by the UE 115.

Transmitter 562 is configured to transmit reference signals, synchronization signals, control information and data to one or more other devices, and receiver 564 is configured to receive reference signals, control information and data from one or more other devices. For example, transmitter 562 may transmit signaling, control information and data to, and receiver 564 may receive signaling, control information and data from, UE 115. In some implementations, transmitter 562 and receiver 564 may be integrated in one or more transceivers. Additionally or alternatively, transmitter 562 or receiver 564 may include or correspond to one or more components of base station 105 described with reference to FIG. 2.

The base station 105 may further include a CJT phase alignment determination module 558. The phase alignment determination module 558 may be configured to determine one or more phase alignment parameters for transmission of one or more CJT components based on one or more phase alignment indications transmitted by the UE 115. The phase alignment determination module 558 may also be configured to cause the transmitter 562 to transmit DCI for triggering phase alignment indication transmissions, CMR transmissions for measurement by the UE 115, and configuration information for configuring the UE 115 for phase alignment determination and to cause the receiver 562 to receive phase alignment indication transmissions from the UE 115. The base station 105 may include a CJT message transmission module 560. The CJT message transmission module 560 may be configured to cause the transmitter 562 to transmit one or more CJT components having a phase alignment determined based on phase alignments determined by the CJT phase alignment determination module 558.

In some implementations, wireless communications system 500 implements a 5G NR network. For example, wireless communications system 500 may include multiple 5G-capable UEs 115 and multiple 5G-capable base stations 105, such as UEs and base stations configured to operate in accordance with a 5G NR network protocol such as that defined by the 3GPP.

During operation of wireless communications system 300, base station 105 may transmit configuration information 574 to the UE 115. Such configuration information may, for example, include configuration information for transmission of one or more phase alignment indications 576 from the UE 115 to the base station 105 and/or other base stations. The configuration information 574 may, for example, configure the UE with resources for transmission of one or more uplink reference signal transmissions, such as SRS resources, that can be measured for estimation of phase at the base station 105 and/or other base stations. The configuration information 574 may further include one or more timing thresholds, such as minimum time durations between receipt, by the UE, of downlink control information (DCI) 570 and transmission of one or more phase alignment indications 576 based on the received DCI.

In some embodiments, the base station 105 may transmit a tracking reference signal (TRS), such as CMR transmission 572, to the UE 115 for measurement by the UE 115 to determine a phase alignment. In some embodiments, the base station 105 may transmit multiple CMR transmissions, such as from multiple TRPs of the base station 105, and the UE may measure and compare the CMR transmissions to determine a phase alignment of the CMR transmissions from multiple TRPs of the base station 105. In some embodiments, the UE 15 may receive CMR transmissions from TRPs of other base stations and may compare the CMR transmissions from the TRPs of other base stations with the CMR transmissions from the TRP(s) of the base station 105 to determine a phase alignment of transmissions from the TRPs. For example, the UE 115 may receive and measure CMR transmissions from multiple TRPs and may calculate one or more phase differences between CMR transmissions from multiple TRPs. Based on the calculated phase difference(s), the UE 115 may transmit a phase alignment indication 576, such as a report indicating the calculated phase difference, to the base station 105 and, in some embodiments, to other base stations including other TRPs. In some embodiments, multiple reports including phase differentials for multiple TRPs of a base station 105 may be transmitted from the UE 115 to the base station 105. Such a report may, for example, be transmitted as part of a tracking reference signal (TRS) time-domain channel properties (TDCP) reporting procedure. For example, the phase alignment indication 576 may be included in a TRS TDCP report along with other information, such as a measured doppler spread or a quantized amplitude of a time-domain correlation profile for the CMR transmissions or other transmissions. Thus, when the UE 115 receives multiple CMR transmissions from multiple TRPs, the UE 115 may measure and report relative phases across the multiple TRPs in a phase alignment indication 576, using a selected CMR transmission from a selected TRP as a reference. Such reporting may be in addition to non-zero coefficient (NZC) reporting of CJT CSI reports. In some embodiments, a time domain restriction may be imposed on CMR transmissions 572, and an indication may be transmitted to the UE that per-TRP CMR transmission is performed for phase recovery purposes. In some embodiments, CMR transmissions 572 from multiple TRPs may be CJT transmitted to the UE 115. In some embodiments, a co-phasing delta may be used in transmission of CJT CMR transmissions 572. A unified transmit control information (TCI) framework extension may enable such CJT CMR transmissions, and a quasi-colocation (QCL) status of the CJT CMR transmissions may be indicated.

Following receipt of one or more phase alignment indications 576 including one or more reports, the base station 105 may then transmit a CJT message 578 in accordance with the received phase alignment indication 576. For example, a CJT message 578 may be transmitted at a time or using resources in accordance with the phase alignment indication 576. For example, the CJT message 578 may include a first CJT component transmitted by a first TRP of the base station 105 and a second CJT component transmitted by a second TRP of the base station 105 or a TRP of another base station. The CJT components may be aligned in phase and may, together, form a CJT message 578 In some embodiments, the CJT message may include CJT components from two or more TRPs. In some embodiments, for example, the CJT message 578 may be a CJT PDSCH, and the CJT PDSCH may share a source quasi-collocation with the CMR transmissions, but with the reported phase alignment indication applied to provide phase alignment of the CJT components of the CJT message 578.

In some embodiments, the base station 105 may transmit downlink control information (DCI) 570 to trigger transmission of a phase alignment indication 576. For example, DCI 570 may comprise scheduling DCI for transmission of one or more CJT messages 578 and may be transmitted by one or more TRPs of base station 105 or other base stations. As another example, DCI 570 may include DCI for triggering aperiodic CSI-RS measurement by the UE 115. When DCI 570 is received by the UE 115, the UE 115 may transmit one or more phase alignment indications 576 to the base station 105. The phase alignment indication 576 may, for example, include one or more reference signals, such as one or more SRS. Thus, in some embodiments, one or more SRS may be scheduled along with CSI-RS based on DCI triggering aperiodic CSI-RS measurement by the UE. In some embodiments, the UE 115 may be provided with a time offset between receipt of DCI 570 and transmission of one or more reference signals of phase alignment indication 576 and/or a time offset between transmission of the one or more reference signals of phase alignment indication 576 and receipt of one or more components of CJT message 578. Such an offset may, for example, be provided in DCI 570, in configuration information 574, or stored in a memory of UE 115. In some embodiments, such an offset may be a minimum timing offset. The use of such an offset may, in some embodiments, be toggled on and off. For example, use of an offset may be activated, by the UE 115 in response to an activation trigger from the base station 105 in configuration information 574, in scenarios where phase coherence is ambiguous, such as when a UE 115 position is changed. Thus, a reference signal may be transmitted between receipt of downlink control information 570 by the UE 115 and transmission of one or more CJT message 578 components by one or more TRPs of the base station 105 and/or one or more other TRPs of other base stations. In some embodiments, the base station 105 may configure the UE 115 to transmit reference signals periodically, such as paired with CSI-RS transmissions from a base station, for CJT transmission. Such periodic transmission may be complemented by reference signal transmission triggered by DCI, as discussed herein.

Receipt of DCI 570 may trigger the UE 115 to transmit one or more reference signals to one or more TRPs, such as one or more TRPs of base station 105 or other base stations. The TRPs may measure the reference signals to determine one or more phase alignment parameters, such as one or more phase differences between transmissions from the TRPs at the UE 115. For example, in some embodiments, phase alignment indication 576 transmission may be triggered by both scheduling DCI for CJT PDSCH transmissions and DCI triggering aperiodic CSI-RS reception by the UE. Thus, in some embodiments, TRPs may measure transmitted reference signals both when CSI-RS transmission occurs and when CJT PDSCH transmission occurs. In such embodiments, the phase difference between the two sets of measurements may be compared and compensated for when transmitting CJT PDSCH transmissions. The TRPs may use the measurements to determine one or more transmission parameters, such as time or frequency resources, TCI state, or QCL configuration, for transmission of one or more CJT message 578 components from the TRPs to the UE. For example, the TRPs may transmit multiple CJT message 578 components in phase alignment based on measurements performed on the reference signals of the phase alignment indication 576. The CJT message 578 components may, for example, include CJT PDSCH messages transmitted by TRPs and scheduled according to the DCI 570 with phase alignment determined according to the phase alignment indication 576.

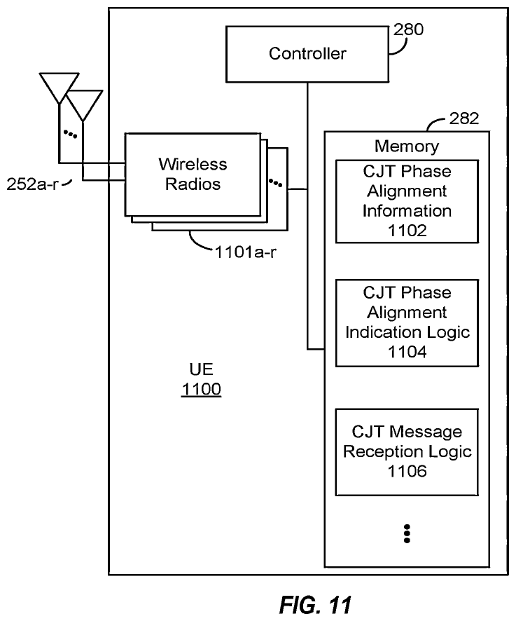

FIG. 6 is a flow diagram illustrating an example process 600 that supports a UE-assisted phase recovery for CJT according to one or more aspects. Operations of process 600 may be performed by a UE, such as UE 115 described above with reference to FIGS. 1, 2, 4A-B, and 5, or a UE described with reference to FIG. 11. For example, example operations (also referred to as “blocks”) of process 600 may enable UE 115 to support UE-assisted phase recovery for CJT.

In block 602, a first UE may transmit an indication of a phase alignment associated with a first network node and a second network node at the first UE. Such an indication may, for example, be transmitted to the first network node and/or to the second network node. The first network node and the second network node may, for example, be TRPs of the same base station, or TRPs of different base stations, configured to communicate with the UE in a CJT configuration. To maintain communication in the CJT configuration, the TRPs may transmit CJT components to the UE that are aligned in phase. The transmitted indication of the phase alignment may assist network nodes, such as TRPs, in maintaining phase alignment of CJT components even when the UE is moved or other network conditions change.

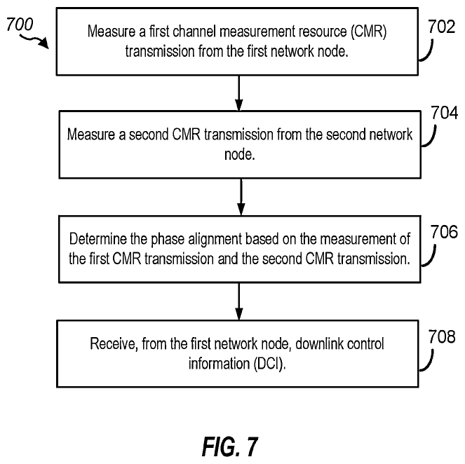

In some embodiments, the indication of the phase alignment may include a report based on measurements of one or more tracking reference signals, such as CMR transmissions, from the first and second network nodes, such as described herein with respect to FIG. 7. For example, the report may include one or more phase difference parameters, such as one or more indications of one or more relative phases across multiple TRPs using one TRP as a reference., determined based on measurements of CMR transmissions from the first and second network nodes. That is, the UE may perform CSI-RS measurements on the CMR transmissions and may report a co-phasing delta, such as a phase difference, across the transmissions from the TRPs to each individual TRP. Such reporting may be separate from and in addition to NZC reporting in a CJT CSI report context. In some embodiments, the UE may transmit multiple indications of phase alignments to multiple TRPs configured to communicate with the UE together in a CJT configuration. For example, the UE may select one TRP as a reference, and may transmit reports indicating measured phases of CMR signals from other TRPs relative to a phase of a CMR signal from the reference TRP, such as respective phase differences between CMR transmissions from each of the other TRPs and a CMR transmission from the selected TRP. Such a report may be transmitted as part of a TDCP reporting framework, such as along with a measured doppler spread or quantized amplitude of a time-domain correlation profile. In some embodiments a time domain restriction may be imposed, and the UE may indicate that the report is for phase recovery purposes, such as when individual reports are transmitted to individual TRPs. Thus, such an indication may be used by each TRP engaging in a CJT transmission session with the UE to verify that CJT components are aligned in phase at the UE. In particular, a CJT PDSCH transmission from a TRP may be initially configured for transmission quasi-collocated with an earlier CMR transmission from the TRP, but such quasi-collocation may be adjusted based on the report transmitted from the UE to the TRP.

In some embodiments, the indication of the phase alignment may include one or more uplink reference signals, such as one or more sounding reference signals (SRSs) transmitted on one or more SRS resources. For example, the first UE may transmit such SRSs to each network node participating in the CJT communication session with the first UE, such as to each TRP. The network nodes may then measure the reference signals and use the measurements of the reference signals for phase estimation and alignment of CJT components to the first UE. For example, a UE may be configured with multiple SRS resources, and each SRS resource within an SRS resource set may correspond to a TRP participating in the CJT communication session. In some embodiments, the uplink reference signals may be transmitted to the network nodes simultaneously. For example, the first UE may be configured with multi-panel UE capabilities, and may be able to simultaneously transmit multiple SRSs as part of the indication of the phase alignment to multiple TRPs. Such TRPs may be part of a same base station or may be parts of different base stations. In some embodiments, the first UE may not be capable of or configured for simultaneous transmission of SRSs. In such embodiments, the first UE may perform SRS sweeping for transmitting the indication of the phase alignment. When performing SRS sweeping, timing restrictions may be applied to the SRS transmissions to facilitate phase continuity across the SRS transmissions, to allow accurate estimation of phase alignment at each TRP. In some embodiments, the UE may preempt transmission and/or reception of other signals during an SRS-based TRP phase recovery procedure, such as during transmission of the indication of the phase alignment. The SRS resources on which the first UE transmits the SRSs may be scheduled by a base station, such as a base station including the first TRP, to facilitate UE-assisted phase recovery for CJT transmission. In some embodiments, the Transmission Configuration Indicator (TCI) and/or spatial relation of configured SRS resources may be specified by the base station with CSI-RS resources used for CMR transmission as the source reference signal. In some embodiments, the indication of the phase alignment, such as the reference signal transmissions may be scheduled to occur at a predetermined time after receipt of DCI for scheduling a CJT PDSCH and/or before transmission of the CJT PDSCH. In some embodiments, transmission of the reference signals may be triggered by receipt of DCI for scheduling of a CJT PDSCH from the first network node or the second network node. In some embodiments, a time offset between receipt of the DCI and transmission of the reference signals and/or between transmission of the reference signals and transmission of the CJT PDSCH may be indicated to the first UE, such as in a memory of the first UE or signaled by the first network node. Thus, the first UE may wait a period of time after receiving a triggering DCI before transmitting the reference signal, or may transmit the reference signal a period of time before a period of time scheduled for transmission of a CJT PDSCH by the first network node and/or by the second network node. In some embodiments, transmission of the reference signals may be triggered by receipt of DCI triggering an aperiodic CSI-RS reception by the UE. In some embodiments, transmission of the reference signals may be triggered both by receipt of DCI for scheduling a CJT PDSCH and by receipt of DCI triggering an aperiodic CSI-RS reception. Thus, the indication of the phase alignment may be transmitted by the first UE and measured by the first and/or second network nodes both prior to transmission of a CJT PDSCH and prior to transmission of a CSI report in response to the triggered aperiodic CSI-RS reception. The first and second network nodes, which may be TRPs, may thus measure and compare a phase difference between two instances of transmission of reference signals from the first UE, and transmission parameters for transmission of a CJT PDSCH may be adjusted based on such measurements to maintain phase alignment.

In block 604, the first UE may receive, from the first network node, a first CJT component after transmitting the indication of the phase alignment. The first network node may be a first TRP. For example, the first network node may receive the indication of the phase alignment from the first UE and may adjust one or more parameters of the first CJT component to maintain a phase alignment of the first CJT component with other CJT components, such as a second CJT component, from other network nodes, such as other TRPs, based on the indication of the phase alignment. In some embodiments, the first CJT component may be a first CJT PDSCH transmission

In block 606, the first UE may receive, from the second network node, a second CJT component after transmitting the indication of the phase alignment. The second network node may be a second TRP. For example, the second network node may receive the indication of the phase alignment from the first UE and may adjust one or more parameters of the second CJT component to maintain a phase alignment of the second CJT component with the first CJT component based on the indication of the phase alignment. A first phase of the first CJT component may thus be aligned with a second phase of the second CJT component based on the transmitted indication of the phase alignment. CJT components from first and second network nodes may, for example, be aligned in phase when phases of the components are within a threshold variance of each other, such as a threshold phase difference, when the components are received by the UE. In some embodiments, the second CJT component may be a second CJT PDSCH transmission component. Thus, phase alignment of the CJT PDSCH components transmitted by TRPs to a UE may be maintained based on a phase alignment indication transmitted by a UE.

FIG. 7 is a flow diagram illustrating an example process 700 that supports a UE-assisted phase recovery for CJT according to one or more aspects. Operations of process 700 may be performed by a UE, such as UE 115 described above with reference to FIGS. 1, 2, 4A-B, and 5, or a UE described with reference to FIG. 11. For example, example operations (also referred to as “blocks”) of process 700 may enable UE 115 to support UE-assisted phase recovery for CJT.

In block 702, the first UE may measure a first CMR transmission from the first network node. In block 704, the first UE may measure a second CMR transmission from the second network node. The first network node may be a first TRP, and the second network node may be a second TRP. The first CMR transmission and the second CMR transmission may, for example, be transmitted by first and second TRPs engaged in a CJT communication session with the first UE. The first UE may measure the first and second CMR transmissions to determine a phase of each of the first and second CMR transmissions, in order to determine a relative phase of transmissions from the first and second network nodes at the first UE for phase recovery purposes. The first and second CMR transmissions may, for example, be transmitted in a CJT transmission. The first and second CMR transmissions may be transmitted with a phase alignment, in some embodiments with a co-phasing delta. In some embodiments, the CMR transmissions may be TRS transmissions. In some embodiments, CMR transmissions from more than two network nodes may be measured.

In block 706, the first UE may determine the phase alignment, such as the phase alignment described with respect to the phase alignment indicator of block 602 of FIG. 6, based on the measurement of the first CMR transmission and the second CMR transmission. For example, a relative phase across the first and second CMR transmissions may be determined based upon the measurements of the first and second CMR transmissions. The relative phase may be a calculated phase differential between the CMR transmission received from the first network node and the CMR transmission received from the second network node at the first UE. The relative phase may then be transmitted in a report of the indication of the phase alignment described with respect to block 602 of FIG. 6. Thus, blocks 702-706 may be performed in order to determine the indication of the phase alignment of block 602 of FIG. 6.

In block 708, the first UE may receive, from the first network node, DCI. For example, as described with respect to block 602 of FIG. 6, transmission of the indication of the phase alignment may be triggered by such DCI. The DCI may, for example, be DCI for scheduling a CJT PDSCH transmission and/or DCI for triggering an aperiodic CSI-RS transmission for reception by the first UE. The DCI may include first scheduling information for the first CJT component. Thus, block 708 may be performed prior to block 602 of FIG. 6, and may trigger the operations of block 602. That is, receipt of the DCI at block 708 may trigger transmission of one or more reference signals, as described with respect to block 602.

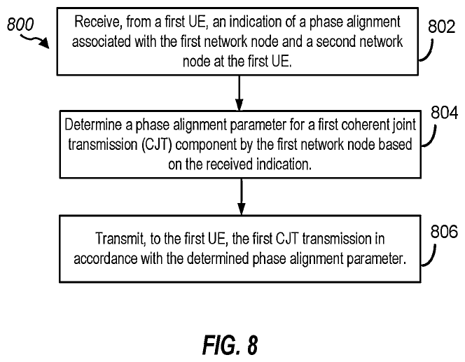

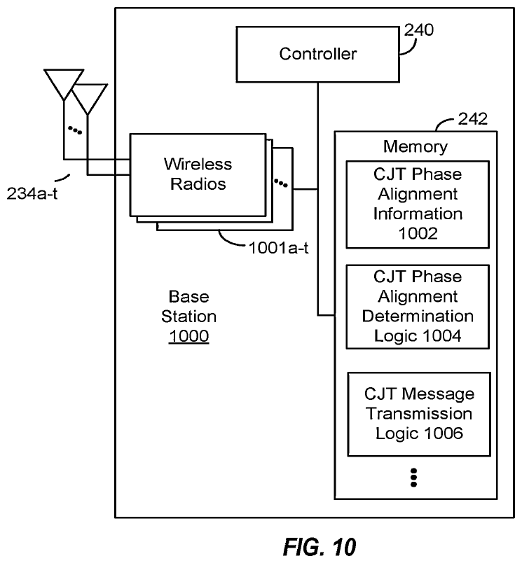

FIG. 8 is a flow diagram illustrating an example process 800 that supports a UE-assisted phase recovery for CJT according to one or more aspects. Operations of process 800 may be performed by a base station, such as base station 105 described above with reference to FIGS. 1, 2, and 5, or a base station described with reference to FIG. 10. For example, example operations (also referred to as “blocks”) of process 800 may enable base station 105 to support UE-assisted phase recovery for CJT. In some embodiments, such a base station may include one or more TRPs.

In block 802, a first network node may receive, from a first UE, an indication of a phase alignment associated with the first network node and a second network node at the first UE. The first and second network nodes may, for example, be TRPs configured to communicate with the first UE in a CJT configuration. Thus, the indication of the phase alignment may allow the first network node to maintain phase alignment of CJT components with CJT components from the second network node at the first UE. The indication of the phase alignment may be an indication of a phase alignment as described with respect to block 602 of FIG. 6. For example, the indication of the phase alignment may include a report, based on one or more CMR transmissions transmitted by the first network node, or one or more reference signal transmissions.

In block 804, the first network node may determine a phase alignment parameter for a first CJT component by the first network node based on the received indication. For example, a quasi-collocation (QCL) status, a TCI configuration, and/or one or more time or frequency resources of the first CJT component may be adjusted based on the received indication of the phase alignment. Thus, a phase alignment parameter may include a QCL status, a TCI configuration, and/or one or more time or frequency resources for transmission of the first CJT component.

In block 806, the first network node may transmit, to the first UE, the first CJT component in accordance with the determined phase alignment parameter. The CJT component may, for example, be a CJT PDCCH transmission component. The first CJT component may, for example, be aligned in phase with one or more other CJT components from one or more other network nodes participating in a CJT communication session with the first network node and the first UE. In some embodiments, the second network node may perform steps similar to those described with respect to blocks 804 and 806 for transmission of a second CJT component that is aligned in phase with the first CJT component when received by the first UE.

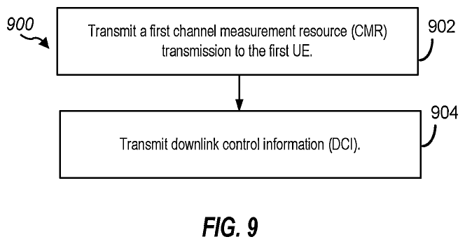

FIG. 9 is a flow diagram illustrating an example process 900 that supports a UE-assisted phase recovery for CJT according to one or more aspects. Operations of process 900 may be performed by a base station, such as base station 105 described above with reference to FIGS. 1, 2, and 5, or a base station described with reference to FIG. 10. For example, example operations (also referred to as “blocks”) of process 900 may enable base station 105 to support UE-assisted phase recovery for CJT. In some embodiments, such a base station may include one or more TRPs. In some embodiments, operations of the process 900 may be performed along with the process 800 of FIG. 8.

In block 902, a first network node may transmit a first CMR transmission to a first UE. Such a CMR transmission may, for example, be transmitted in a CJT configuration with one or more other CMR transmissions from other network nodes, such as other TRPs. The first network node may, for example, be a first base station or a first TRP of a first base station. Other network nodes may, for example, be other TRPs of the first base station or other TRPs of other base stations. Thus, the first CMR transmission may be transmitted, along with other CMR transmissions, in a CJT configuration having a phase alignment between the CMR transmissions, to a UE, to enable the UE to estimate a phase alignment of the CMR transmissions. The first CMR transmission may, for example, be a CMR transmission as described with respect to block 702 of FIG. 7.

In block 904, the first network node may transmit DCI to the first UE. For example, as described with respect to block 602 of FIG. 6, transmission of the indication of the phase alignment may be triggered by such DCI. The DCI may, for example, include DCI for scheduling a CJT PDSCH transmission by the first network node and/or DCI for triggering an aperiodic CSI-RS reception by the first UE. The DCI may include first scheduling information for the first CJT component. Thus, block 904 may be performed prior to block 802 of FIG. 8, and may trigger the first UE to transmit the indication of the phase alignment described with respect to block 802.

FIG. 10 is a block diagram of an example base station 1000 that supports UE-assisted phase recovery for CJT according to one or more aspects. Base station 1000 may be configured to perform operations, including the blocks of processes 800 and/or 900 described with reference to FIGS. 8-9. In some implementations, base station 1000 includes the structure, hardware, and components shown and described with reference to base station 105 of FIGS. 1-2 and 5. For example, base station 1000 may include controller 240, which operates to execute logic or computer instructions stored in memory 242, as well as controlling the components of base station 1000 that provide the features and functionality of base station 1000. Base station 1000, under control of controller 240, transmits and receives signals via wireless radios 1001a-t and antennas 234a-t. Wireless radios 1001a-t include various components and hardware, as illustrated in FIG. 2 for base station 105, including modulator and demodulators 232a-t, transmit processor 220, TX MIMO processor 230, MIMO detector 236, and receive processor 238.

As shown, the memory 242 may include CJT phase alignment information 1002, CJT phase alignment determination logic 1004, and CJT message transmission logic 1006. CJT phase alignment information 1002 may include information similar to CJT phase alignment information 556 of FIG. 5. CJT phase alignment determination logic 1004 may be configured to determine one or more phase alignment parameters for one or more CJT components by the base station 1000, as described herein, such as with respect to FIGS. 8-9. CJT message transmission logic 1006 may be configured to transmit one or more CJT message components to a UE according to determined phase alignment parameters, as described herein, such as with respect to FIGS. 8-9. Base station 1000 may receive signals from or transmit signals to one or more UEs, such as UE 115 of FIGS. 1-3 or UE 1100 of FIG. 1.

FIG. 11 is a block diagram of an example UE 1100 that supports UE-assisted phase recovery for CJT according to one or more aspects. UE 1100 may be configured to perform operations, including the blocks of a process described with reference to FIGS. 6-7. In some implementations, UE 1100 includes the structure, hardware, and components shown and described with reference to UE 115 of FIGS. 1-2 and 5. For example, UE 1100 includes controller 280, which operates to execute logic or computer instructions stored in memory 282, as well as controlling the components of UE 1100 that provide the features and functionality of UE 1100. UE 1100, under control of controller 280, transmits and receives signals via wireless radios 501a-r and antennas 252a-r. Wireless radios 1101a-r include various components and hardware, as illustrated in FIG. 2 for UE 115, including modulator and demodulators 254a-r, MIMO detector 256, receive processor 258, transmit processor 264, and TX MIMO processor 266.

As shown, memory 282 may include CJT phase alignment information 1102, CJT phase alignment indication logic 1104, and CJT message reception logic 1106. CJT phase alignment information 1102 may include information similar to CJT phase alignment information 506 of FIG. 5. CJT phase alignment indication logic 1102 may be configured to determine and transmit a CJT phase alignment indication as described herein, such as with respect to FIGS. 6-7. CJT message reception logic 1106 may be configured to receive one or more CJT message components from one or more TRPs as described herein, such as with respect to FIGS. 6-7. UE 1100 may receive signals from or transmit signals to one or more network entities, such as base station 105 of FIGS. 1-2 and 5 or a base station as illustrated in FIG. 10.

It is noted that one or more blocks (or operations) described with reference to FIGS. 6-9 may be combined with one or more blocks (or operations) described with reference to another of the figures. For example, one or more blocks (or operations) of FIG. 6 may be combined with one or more blocks (or operations) of FIG. 7. As another example, one or more blocks associated with FIG. 8 may be combined with one or more blocks associated with FIG. 9. As another example, one or more blocks associated with FIG. 6 may be combined with one or more blocks (or operations) associated with FIGS. 1-2, 4A-B, and 5. Additionally, or alternatively, one or more operations described above with reference to FIGS. 1-2, 4A-B, and 5 may be combined with one or more operations described with reference to FIG. 10 or 11.

In one or more aspects, techniques for supporting UE-assisted phase recovery for CJT may include additional aspects, such as any single aspect or any combination of aspects described below or in connection with one or more other processes or devices described elsewhere herein. In a first aspect, supporting UE-assisted phase recovery for CJT may include an apparatus, such as a first UE, configured to transmit an indication of a phase alignment associated with a first network node and a second network node, receive, from the first network node, a first coherent joint transmission (CJT) component after transmitting the indication of the phase alignment, and receive, from the second network node, a second CJT component after transmitting the indication of the phase alignment, wherein a first phase of the first CJT component is aligned with a second phase of the second CJT component. Additionally, the apparatus may perform or operate according to one or more aspects as described below. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, to transmit the indication of the phase alignment the apparatus is further configured to transmit one or more uplink reference signals.

In a third aspect, in combination with one or more of the first aspect or the second aspect, the apparatus is further configured to transmit a first uplink reference signal to the first network node and to transmit a second uplink reference signal to the second network node while transmitting the first uplink reference signal.

In a fourth aspect, in combination with one or more of the first aspect through the third aspect, the apparatus is further configured to receive, from the first network node, downlink control information (DCI) comprising first scheduling information for the first CJT component, wherein the at least one processor is further configured to transmit the uplink reference signal based on the first scheduling information for the first CJT component.

In a fifth aspect, in combination with one or more of the first aspect through the fourth aspect, the first CJT component comprises a CJT physical downlink shared channel (PDSCH) transmission component.

In a sixth aspect, in combination with one or more of the first aspect through the fifth aspect, to transmit the indication of the phase alignment the apparatus is further configured to transmit a phase difference report.

In a seventh aspect, in combination with one or more of the first aspect through the sixth aspect, the apparatus is further configured to measure a first channel measurement resource (CMR) transmission from the first network node, measure a second CMR transmission from the second network node, and determine the phase alignment based on the measurement of the first CMR transmission and the second CMR transmission.

In an eighth aspect, in combination with one or more of the first aspect through the seventh aspect, wherein the first CMR transmission and the second CMR transmission are CJT components.

In a ninth aspect, in combination with one or more of the first aspect through the eighth aspect, the first network node comprises a first transmission and reception point (TRP) and the second network node comprises a second TRP.

In one or more aspects, techniques for supporting UE-assisted phase recovery for CJT may include additional aspects, such as any single aspect or any combination of aspects described below or in connection with one or more other processes or devices described elsewhere herein. In a tenth aspect, supporting UE-assisted phase recovery for CJT may include an apparatus, such as a first network node, configured to receive, from a first UE, an indication of a phase alignment associated with the first network node and a second network node at the first UE, determine a phase alignment parameter for a first coherent joint transmission (CJT) component by the first network node based on the received indication, and transmit, to the first UE, the first CJT component in accordance with the determined phase alignment parameter. Additionally, the apparatus may perform or operate according to one or more aspects as described below. In some implementations, the apparatus includes a wireless device, such as a base station. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In an eleventh tenth aspect, to receive the indication of the phase alignment, the apparatus is further configured to receive one or more uplink reference signals, and to determine the phase alignment parameter for the first CJT component, the apparatus is further configured to measure one or more of the one or more uplink reference signals.

In a twelfth aspect, in combination with one or more of the tenth through eleventh aspects, the apparatus is further configured to transmit, to the first UE, downlink control information (DCI) comprising first scheduling information for the first CJT component.

In a thirteenth aspect, in combination with one or more of the tenth through twelfth aspects, the first CJT component comprises a CJT physical downlink shared channel (PDSCH) transmission.

In a fourteenth aspect, in combination with one or more of the tenth through thirteenth aspects, to receive the indication of the phase alignment the at apparatus is further configured to execute the processor-readable code to cause the at least one processor to receive a phase difference report, and the apparatus is further configured to determine the phase alignment parameter based on the phase difference report.

In a fifteenth aspect, in combination with one or more of the tenth through fourteenth aspects, the apparatus is further configured to transmit a first channel measurement resource (CMR) transmission to the first UE.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-11 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a network node may be a TRP, which may, in some embodiments, be integrated in a base station alone or with one or more additional TRPs. As another example, a first network node may be configured to communicate with a second network node or a third network node. In one aspect of this example, the first network node may be a UE, the second network node may be a TRP, and the third network node may be a TRP. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a first user equipment (UE), the method comprising:
transmitting an indication of a phase alignment associated with a first network node and a second network node at the first UE;
receiving, from the first network node, a first coherent joint transmission (CJT) component after transmitting the indication of the phase alignment; and
receiving, from the second network node, a second CJT component after transmitting the indication of the phase alignment, wherein a first phase of the first CJT component is aligned with a second phase of the second CJT component.

2. The method of claim 1, wherein transmitting the indication of the phase alignment comprises transmitting one or more uplink reference signals.

3. The method of claim 2, wherein transmitting the one or more uplink reference signals comprises:
transmitting a first uplink reference signal to the first network node; and
transmitting a second uplink reference signal to the second network node while transmitting the first uplink reference signal.

4. The method of claim 2, further comprising:
receiving, from the first network node, downlink control information (DCI) comprising first scheduling information for the first CJT component, wherein transmitting the one or more uplink reference signals is performed based on the first scheduling information for the first CJT component.

5. The method of claim 2, wherein the first CJT component comprises a CJT physical downlink shared channel (PDSCH) transmission component.

6. The method of claim 1, wherein transmitting the indication of the phase alignment comprises transmitting a phase difference report.

7. The method of claim 6, further comprising:
measuring a first channel measurement resource (CMR) transmission from the first network node;
measuring a second CMR transmission from the second network node; and
determining the phase alignment based on the measurement of the first CMR transmission and the second CMR transmission.

8. The method of claim 7, wherein the first CMR transmission and the second CMR transmission are CJT components.

9. The method of claim 1, wherein the first network node comprises a first transmission and reception point (TRP) and the second network node comprises a second TRP.

10. A first user equipment (UE) comprising:
a memory storing processor-readable code; and
at least one processor coupled to the memory, the at least one processor configured to execute the processor-readable code to cause the at least one processor to:
transmit an indication of a phase alignment associated with a first network node and a second network node at the first UE;
receive, from the first network node, a first coherent joint transmission (CJT) component after transmitting the indication of the phase alignment; and
receive, from the second network node, a second CJT component after transmitting the indication of the phase alignment, wherein a first phase of the first CJT component is aligned with a second phase of the second CJT component.

11. The first UE of claim 10, wherein to transmit the indication of the phase alignment the at least one processor is further configured to execute the processor-readable code to cause the at least one processor to transmit one or more uplink reference signals.

12. The first UE of claim 11, wherein to transmit the uplink reference signal, the at least one processor is further configured to execute the processor-readable code to cause the at least one processor to:
transmit a first uplink reference signal to the first network node; and
transmit a second uplink reference signal to the second network node while transmitting the first uplink reference signal.

13. The first UE of claim 11, wherein the processor is further configured to execute the processor-readable code to cause the at least one processor to:
receive, from the first network node, downlink control information (DCI) comprising first scheduling information for the first CJT component, wherein the at least one processor is further configured to transmit the uplink reference signal based on the first scheduling information for the first CJT component.

14. The first UE of claim 11, wherein the first CJT component comprises a CJT physical downlink shared channel (PDSCH) transmission component.

15. The first UE of claim 10, wherein to transmit the indication of the phase alignment the at least one processor is further configured to execute the processor-readable code to cause the at least one processor to transmit a phase difference report.

16. The first UE of claim 15, wherein the at least one processor is further configured to execute the processor-readable code to cause the at least one processor to:
measure a first channel measurement resource (CMR) transmission from the first network node;
measure a second CMR transmission from the second network node; and
determine the phase alignment based on the measurement of the first CMR transmission and the second CMR transmission.

17. The first UE of claim 16, wherein the first CMR transmission and the second CMR transmission are CJT components.

18. The first UE of claim 10, wherein the first network node comprises a first transmission and reception point (TRP) and the second network node comprises a second TRP.

19. A method of wireless communication performed by a first network node, the method comprising:
receiving, from a first user equipment (UE), an indication of a phase alignment associated with the first network node and a second network node at the first UE;
determining a phase alignment parameter for a first coherent joint transmission (CJT) component by the first network node based on the received indication; and
transmitting, to the first UE, the first CJT component in accordance with the determined phase alignment parameter.

20. The method of claim 19, wherein receiving the indication of the phase alignment comprises receiving one or more uplink reference signals, and wherein determining the phase alignment parameter for the first CJT component comprises measuring one or more of the one or more uplink reference signals.

21. The method of claim 20, further comprising:
transmitting, to the first UE, downlink control information (DCI) comprising first scheduling information for the first CJT component.

22. The method of claim 20, wherein the first CJT component comprises a CJT physical downlink shared channel (PDSCH) transmission component.

23. The method of claim 19, wherein receiving the indication of the phase alignment comprises receiving a phase difference report, and wherein the phase alignment parameter is determined based on the phase difference report.

24. The method of claim 23, further comprising:
transmitting a first channel measurement resource (CMR) transmission to the first UE.

25. A first network node comprising:
a memory storing processor-readable code; and
at least one processor coupled to the memory, the at least one processor configured to execute the processor-readable code to cause the at least one processor to:
receive, from a first user equipment (UE), an indication of a phase alignment associated with the first network node and a second network node at the first UE;
determine a phase alignment parameter for a first coherent joint transmission (CJT) component by the first network node based on the received indication; and
transmit, to the first UE, the first CJT component in accordance with the determined phase alignment parameter.

26. The first network node of claim 25, wherein to receive the indication of the phase alignment, the at least one processor is further configured to execute the processor-readable code to cause the at least one processor to receive one or more uplink reference signals, and wherein to determine the phase alignment parameter for the first CJT component, the at least one processor is further configured to execute the processor-readable code to cause the at least one processor to measure one or more of the one or more uplink reference signals.

27. The first network node of claim 26, wherein the at least one processor is further configured to execute the processor-readable code to cause the at least one processor to:
transmit, to the first UE, downlink control information (DCI) comprising first scheduling information for the first CJT component.

28. The first network node of claim 26, wherein the first CJT component comprises a CJT physical downlink shared channel (PDSCH) transmission component.

29. The first network node of claim 25, wherein to receive the indication of the phase alignment the at least one processor is further configured to execute the processor-readable code to cause the at least one processor to receive a phase difference report, and wherein the at least one processor is further configured to execute the processor-readable code to cause the at least one processor to determine the phase alignment parameter based on the phase difference report.

30. The first network node of claim 29, wherein the at least one processor is further configured to execute the processor-readable code to cause the at least one processor to:
transmit a first channel measurement resource (CMR) transmission to the first UE.
